(19) United States
(12) Patent Application Publication
(10) Pub. No.: US 2011/0037570 A1
(43) Pub. Date: Feb. 17, 2011

(54) Communication Method for a Radio System and Apparatus and System for Implementing the Method

(75) Inventors: Dieter Horst, Cadolzburg (DE); Matthias Lampe, Wolfenbuettel (DE); Dan Yu, Beijing (CN); Yong Yuan, Beijing (CN); Jie Zhang, Beijing (CN)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, Munchen (DE)

(21) Appl. No.: 12/864,477

(22) PCT Filed: Jan. 21, 2009
(86) PCT No.: PCT/EP2009/050641

§ 371 Date: Nov. 2, 2010

(30) Foreign Application Priority Data
Jan. 24, 2008 (CN) 200810003811.1

(51) Int. Cl. H04B 7/02; H04Q 5/22; H04W 84/12

(52) U.S. Cl. 340/10.3; 455/101; 370/338

(57) ABSTRACT

An apparatus, system and communication method, which is particularly suited for a radio frequency identification system (RFID), wherein a reflection-transmission apparatus is disposed in a radio system and, during a communication process, the reflection and transmission features of reflection-transmission apparatus presented at the radio frequency are changed to introduce a multi-path signal component which changes with time. Consequently, during the communication process, a receiving apparatus receives and combines the multi-path signal component of communication signals and the radio system performs communication by utilizing time diversity effects. The apparatus, system and method provide effective and continued reduction of communication blind spots in the RFID system, thereby improving the overall success rate for the RFID system to read tags and accomplishing a better balance with the overall reading time.

### CROSS-REFERENCE TO RELATED APPLICATIONS

This is a U.S. national stage of International Application No. PCT/EP2009/050641, filed on 21 Jan. 2009. Priority is claimed on Chinese Application No. 200810003811.1, filed on 24 Jan. 2008. The entire content of both applications are incorporated herein by reference.

### BACKGROUND OF THE INVENTION

1. Field of the Invention

The present invention relates to a radiofrequency system and, more particularly, to a communication method for a radiofrequency, and an apparatus and a system for implementing the method. The present invention is particularly suitable for a radiofrequency identification (RFID) system.

2. Description of the Related Art

Broadcast or communication systems based on radiofrequencies are often faced with multi-path propagation effects. That is, because of the reflection and refraction caused by objects in the environment, transmitted wireless signals will reach a receiving point from more than one propagation path. The signal components in different propagation paths have various path delays, phase shifts and signal attenuations.

A typical broadband multi-path channel includes a feature for selecting a frequency. When various signal components are superposed at a receiving point, they may enhance or weaken one another, and this depends on their frequencies. In addition, if transmitters, receivers or some reflective/scattering objects in an environment are moving, then the broadband multi-path channel also includes features that change with time. Due to the abovementioned features of the broadband channel, the broadband system is capable of improving the reception performance of the whole system by using a frequency diversity technology or a time diversity technology, so as to avoid the occurrence of the continued communication blind spots.

A narrowband channel is usually regarded as having a flat frequency feature; therefore such a narrowband band system cannot take full advantage of the benefits of frequency diversity. If the respective multi-path signal components in the system happen to weaken one another when they are superposed at a receiving point, the field intensity of the signal at the receiving point may be too weak, thereby resulting in the occurrence of a continued blind spot. Conventional communication systems generally take advantage of the features of channel changing with time generated by the movement of transmitters and receivers or objects in the environment, to avoid the occurrence of the continued blind spots by the time diversity effects.

However, in some practical applications of some current radio systems, there still exists the problem of the communication blind spots. For example, in the case a radiofrequency identification system (RFID) operating in a narrowband channel, since both a reader and a tag are usually stationary, and generally the other objects in the environment are also stationary, such a radiofrequency identification system can neither take full advantage of the frequency diversity technology, nor rely in the same way as the abovementioned communication systems on the movements of the reader, the tag or other objects to change the channel with time, and to further reduce the continued blind spots by utilizing the time diversity effects.

In addition, as for a wireless local area network (WLAN) system, if the coherent bandwidth of its channel is significantly smaller than its bandwidth utilized, the continued communication blind spots may also occur.

In order to solve the abovementioned problems, one known solution is to arrange a plurality of transmitting and/or receiving antennas on the transmitting side (for example, on the reader) to achieve the diversity effects, so as to reduce the continued blind spots. However, in order to achieve a relatively good diversity effect, it is necessary for these antennas to have certain overlaps over the coverage range, but this will reduce the coverage by the whole system.

Therefore, it is desirable to adopt a new technical solution to solve the problem of the occurrence of the continued communication blind spots in the abovementioned system.

### SUMMARY OF THE INVENTION

It is an object of the present invention to provide a communication method for a radio system, and an apparatus and a system for implementing the method, so as to reduce the continued communication spots in the radio system, and to improve the communication performance of the radio system.

This and other objects and advantages are achieved in accordance with the invention by a communication method for the radio system that comprises setting up a reflection-transmission apparatus in the radio system, during a communication process, changing the reflection transmission apparatus's reflection feature and transmission feature presented at a radiofrequency to introduce a multi-path signal component which changes with time, during the communication process, transmitting communication signals by a transmitting apparatus to a receiving apparatus, receiving and combining the multi-path signal component of the communication signals by the receiving apparatus and performing communication in the radio system by utilizing time diversity effects.

In a preferred embodiment, the radio system is a radiofrequency identification system comprising a reader and at least one tag.

In accordance with the preferred embodiment, the reflection feature and the transmission feature presented at a radiofrequency by the reflection-transmission apparatus is preferably changed synchronously with a readout period of the radiofrequency identification system. Here, steps for synchronizing with the readout period of said radiofrequency identification system comprise detecting a signal sent by the reader, analyzing the signal detected to determine the beginning of one readout period, and at the beginning of one readout period triggering the change of the reflection feature and transmission feature of the reflection-transmission apparatus. A condition for determining the beginning of one readout period is that the signal is at a rising edge.

In accordance with the preferred embodiment, utilizing the time diversity effects to perform communication by the radio system comprises executing by the reader at least two readout periods during one reading process. Here, a first readout period is executed when the reflection-transmission apparatus presents a first reflection feature and a first transmission feature, and a second readout period is executed when the reflection-transmission apparatus presents a second reflection feature and a second transmission feature and the reading results of all of the readout periods are combined into an overall reading result of the reading process. Preferably, during the one reading process, the reader queries all tags in the first readout period, and in the subsequent readout periods, only queries those tags which are not read successfully in the previous readout period.

In accordance with the disclosed embodiments of the method of the invention, the reflection-transmission apparatus is preferably disposed within the communication range of a sight distance from the reader.

In accordance with the disclosed embodiments of the method of the invention, the reflection feature and transmission feature presented at the radiofrequency by the reflection-transmission apparatus are changed to preferably cause the reflection-transmission apparatus to alternately present a completely reflective feature or a completely transmissive feature.

In accordance with the disclosed embodiments of the method of the present invention, the reflection feature and the transmission feature presented at the radiofrequency by the reflection-transmission apparatus are specifically changed by changing the impedance of the reflection-transmission apparatus.

In another alternative embodiment, the radio system is a wireless local area network system.

The present invention also provides a reflection-transmission apparatus for implementing the abovementioned method, comprising a feature-variable unit for providing and changing a reflection feature and a transmission feature presented at the radiofrequency, and a control unit for controlling the feature-variable unit to change the reflection feature and transmission feature during a communication process.

In an alternative embodiment the feature-variable unit comprises an antenna and a variable impedance unit connected with said antenna. Here, the variable impedance unit changes the reflection feature and the transmission feature presented at the radiofrequency by the antenna by changing its impedance.

In another embodiment, the feature-variable unit comprises a wire grating formed by a biased diode and conducting wire sections. Here, the reflection feature and the transmission feature presented at the radiofrequency by the wire grating are changed by changing the DC bias voltage applied to the biased diode.

In accordance with the disclosed embodiments, the control unit comprises a triggering unit for transmitting a triggering instruction for changing the reflection feature and transmission feature synchronously with the readout period of a radiofrequency identification system, and an executing unit for controlling the feature variable unit to change the reflection feature and transmission feature after having received the triggering instruction of the triggering unit. Here, the triggering unit comprises a signal detecting unit for detecting a signal sent by a reader of the radiofrequency identification system, a synchronous triggering unit for determining the beginning of one readout period according to the signal detected by the signal detecting unit, and for transmitting at the beginning of one readout period a triggering instruction for changing the reflection feature and transmission feature.

The present invention also provides a radiofrequency identification system for implementing the abovementioned method, comprising a tag, a reader for performing communication with the tag by utilizing time diversity effects, and a reflection-transmission apparatus for providing and changing a reflection feature and a transmission feature presented at the radiofrequency during the communication process to introduce a multi-path signal component that changes with time.

Here, the reader comprises a first readout period unit for executing a first readout period when the reflection-transmission apparatus presents a first reflection feature and a first transmission feature, a second readout period unit for executing a second readout period when the reflection-transmission apparatus presents a second reflection feature and a second transmission feature, and a result combining unit for combining the reading results of all of the readout periods into an overall reading result of the reading process.

In addition, the reflection-transmission apparatus comprises a feature-variable unit for providing and changing the reflection feature and the transmission feature presented to the radiofrequency, and a control unit for controlling the feature-variable unit to change the reflection feature and transmission feature during the communication process.

In accordance with the disclosed embodiments of the present invention, the multi-path signal component which changes with time in the radio system is introduced purposefully by arranging the reflection-transmission apparatus with a reflection feature and a transmission feature changing with time. The results of combining such multi-path signal components changing with time and the other multi-path signal components cause the field intensity of the radio system to change with time. As a result, continued blind spots are reduced so that the radio system achieves the goal of improving the communication performance by utilizing the time diversity effects.

The disclosed embodiments of the present invention are particularly suitable for a radio system which has a relatively small range and in an environment in which the objects do not move very much, such as a radiofrequency identification system. In such an environment, the introduction of the reflection-transmission in accordance with the disclosed embodiments of the invention will produce more evident effects than those radio systems which have a relatively large range and in the environments where the objects have relatively strong mobility. Therefore, by introducing the disclosed embodiments of the invention into a radiofrequency identification system, the continued communication blind spots can be effectively reduced, thereby improving the overall success rate for the radiofrequency identification system to read the tags. Furthermore, if the reflection feature and the transmission feature are changed to match the readout period of the radiofrequency identification system in accordance with the disclosed embodiments, then the interference to the communication in the radiofrequency identification system can be avoided as much as possible, and at the same time a better balance can be achieved between the overall reading success rate and the overall reading time.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is an illustration of a schematic block diagram of a radiofrequency identification system in accordance with an embodiment of the present invention;

FIG. 2 is an illustration of an exemplary process for a reflection-transmission apparatus to adjust its reflection feature synchronously with a readout period of the radiofrequency identification system;

FIG. 3 is an illustration of a schematic block diagram of a reader in accordance with an embodiment of the invention;

FIG. 4 is an illustration of a schematic block diagram of a reflection-transmission apparatus in accordance with an embodiment of the invention;

FIGS. 5A and 5B are illustrations of a schematic block diagram of the reflection-transmission Apparatus in accordance with alternative embodiments, in which a feature-variable unit is realized by at least one load resistor;

FIG. 6 is an illustration of a schematic block diagram of a reflection-transmission apparatus in accordance with an alternative embodiment, in which the variable feature is realized by using a biased PIN diode and a grating composed of conductor sections;

FIG. 7 is an illustration of a schematic block diagram of a control unit in accordance with an embodiment of the invention; and

FIG. 8 is an illustration of a schematic block diagram of a control unit in accordance with a preferred embodiment.

### DETAILED DESCRIPTION OF THE PREFERRED EMBODIMENTS

The fundamental principle of the present invention is as follows: a reflection-transmission apparatus 3 is arranged in a radio system, where the reflection-transmission apparatus 3 presents a reflection feature and a transmission feature at a radiofrequency, and therefore by reflective and transmissive effects the reflection-transmission apparatus can produce some influence on a radio signal in the radio system. The reflection-transmission apparatus 3 can change its reflection feature and transmission feature with time to introduce into the communication process of the radio system some multi-path signal components changing with time so that the field intensity at various points within the covering range of the radio system changes with time. Thus, even though in the radio system some blind spots appear in some positions during the communication process, these blind spots will only continue for a limited period of time. Therefore, by utilizing a time diversity effect, the continued blind spots during a communication process can be reduced in said radio system, thereby improving the communication performance.

The method, apparatus and system will be described in detail hereinafter through the implementation of the present invention in a radiofrequency identification system 4.

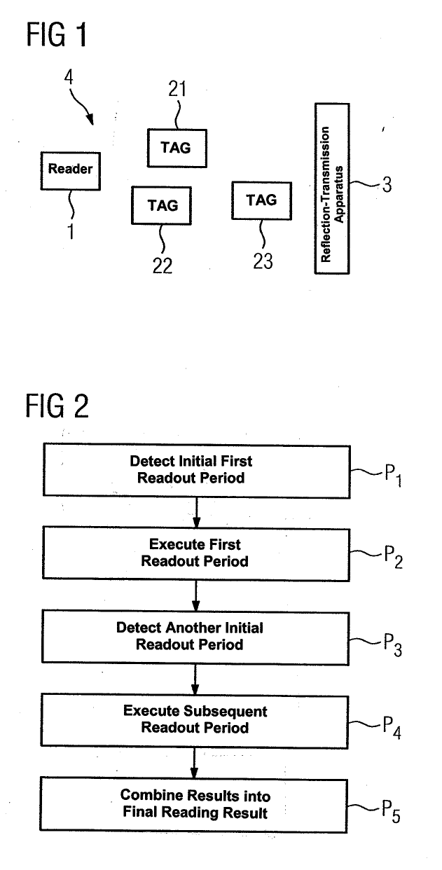

FIG. 1 shows a schematic diagram of an embodiment of the radiofrequency identification system 4 of the present invention. The radiofrequency identification system 4 comprises a reader 1 (which can be a reader/writer), tags 21, 22, 23 and a reflection-transmission apparatus 3. In which case, the tags 21, 22, 23 work in the same way as those in the conventional radiofrequency identification systems. A reader 1 communicates with the tags 21, 22, 23 by utilizing the time diversity effect, i.e., the reader 1 reads from the tags 21, 22, 23. The reflection-transmission apparatus 3 presents a reflection feature and a transmission feature at a radiofrequency, and changes its reflection feature and transmission feature presented at the radiofrequency during a communication process to thereby introduce a multi-path signal component which changes with time during the communication between the reader 1 and the tags 21, 22, 23.

The reflection-transmission apparatus 3 introduces the additional multi-path signal components into the system 4 by way of the reflection and transmission effects, thereby producing influence on the field intensity in the system. More specifically, during that time the reader 1 reads from the tags 21, 22, 23 the reflection-transmission apparatus 3 changes its reflection feature and the transmission feature, to make them change with time, and the additional multi-path components introduced thereby also changes with time correspondingly.

Assuming that in a time section t1 during a reading process in the radiofrequency identification system 4, the reflection-transmission apparatus 3 presents a completely transmissive feature and thus will not produce the additional multi-path signal components due to the reflection; at this time the field intensity after various multi-path signal components have been superposed is s1 at the tag 23, and the field intensity s1 is lower than the signal intensity required by the normal communication between the reader 1 and the tag 23, thereby putting the tag 23 of the time sections t1 at a communication blind spot. In time sections t2 during the reading process, the reflection-transmission apparatus 3 is changed to present a completely reflective feature, thereby producing additional multi-path signal components by the reflection; at this time, since the multi-path signal components produced by the refection of the reflection-transmission apparatus 3 are added, the field intensity after all the multi-path signal components have been superposed will also become s2 at the tag 23, if the field intensity s2 meets the signal intensity required by the normal communication between the reader 1 and the tag 21, then in the time sections t2, there is no longer a communication blind spot at the tag 23. During the entire query process, the tag 23 will not be at a continuous communication blind spot, and it can be read by the reader 1 at least in the time sections t2. In this way, by utilizing the time diversity effects, i.e., in the time section t1 when the reflection-transmission apparatus 3 presents the completely transmissive feature, and in the time section t2 when the reflection-transmission apparatus 3 presents the completely reflective feature, the tag 23 is read repeatedly by the reader 1, and the two reading results are combined.

Consequently, a successful reading of the final result of the tag 23 can be achieved.

For the overall radiofrequency identification system 4, after introducing the reflection-transmission apparatus 3, in terms of statistics in a period of time, the continual communication blind spots appearing in the system will be reduced. As a result, the reading success rate of the whole radiofrequency identification system 4 will be improved.

In order to achieve better results in reducing the continuous blind spots in the radiofrequency identification system 4, it is better for the reflection-transmission apparatus 3 to be placed within the sight distance communication range of the reader 1, so as to ensure that the multi-path signal components produced by the reflection-transmission apparatus 3 can make the field intensity of a point where the tag 21, 22, 23 is located reach the signal intensity required by a normal communication in at least one time section of the communication. If the radiofrequency identification system 4 is located indoors, then a possible arrangement is that the reflection-transmission apparatus can be arranged on an internal wall, so that most of the tags 21, 22, 23 in the radiofrequency identification system 4 can be within the range of influence of the reflection-transmission apparatus 3.

In the above contemplated embodiment, only one reflection-transmission apparatus 3 is disposed. Alternatively, it is possible to have more than one reflection-transmission apparatus 3 disposed in the radiofrequency identification system 4 to introduce the multi-path signal components which changes with time to thereby achieve the goal of reducing the continuous blind spots in the system.

In the radiofrequency identification system 4 of the present invention, the reflection-transmission apparatus 3 can adjust its reflection feature and the transmission feature periodically, and it can also adjust its reflection feature and the transmission feature randomly. In addition, in a preferred embodiment, the reflection-transmission apparatus 3 can synchronously adjust its reflection feature and the transmission feature with the readout period of the radiofrequency identification system 4. Consequently, a better balance between the successful reading rate and the reading speed is achieved. Specifically, the reflection feature and the transmission feature are changed at the beginning of the readout period of the radiofrequency identification system 4 to avoid causing interference to the communication between the reader 1 and the tags 21, 22, 23.

FIG. 2 is an exemplary illustration of a specific process in which the reflection-transmission apparatus 3 adjusts its reflection feature synchronously with the readout period of the radio system 4 of the above embodiment.

This exemplary process is still based on the radiofrequency identification system 4 shown in the first embodiment. Here, the reflection-transmission apparatus 3 can alternately present a completely reflective feature or a completely transmissive feature to the radiofrequency. When the refection-transmission apparatus 3 presents the completely transmissive feature, the tags 21, 22 are not at the communication blind spots and can be read by the reader 1. When the refection-transmission apparatus 3 presents the completely reflective feature, the tag 23 is at a communication blind spot and therefore cannot be read, whereas after the refection-transmission apparatus 3 presents the completely reflective feature thereby introducing the reflected multi-path signal components, the position of the tag 23 will no longer be a communication blind spot, and therefore it can be read by the reader 1 in the reflection-transmission apparatus 3. The detailed communication process is as follows:

Step 1 P₁: the reflection-transmission apparatus 3 detects an initial first readout period of the radiofrequency identification system 4, which can be realized, for example, by detecting a specially set pilot signal sent by the reader 1, or determined by detecting the rising edge of a radio signal sent by the reader 1. At the beginning of the readout period, before the reader 1 sends a command, the reflection-transmission apparatus 3 is changed to present a completely transmissive feature, i.e., no reflection of the multi-path signal components occurs.

Step 2 P₂: the reader 1 executes the first readout period. The process of the first readout period can be the same as the process of a readout period in the art. For example, the reader 1 first sends a select command, and the labels S1 of the tags 21, 22, 23 are all set to A. Then, the reader 1 sends one or several query commands. During the readout period, the tags 21, 22 are not at communication blind spots, and can be read successfully by the reader 1. Whereas the tag 23 is at a communication blind spot, and cannot be read by the reader 1. Therefore, after finishing the first readout period, the labels S1 of the tag 21, 22 are set to B, while the label S1 of the tag 23 remains as A.

Step 3 P₃: the reflection-transmission apparatus 3 detects another initial readout period (the readout period after the first readout period will be called a subsequent readout period hereinafter) of the radiofrequency identification system 4, and the detection can be realized in the same way as in step 1. At the beginning of the readout period, before the reader 1 sends a command, the reflection-transmission apparatus 3 is changed to present a completely reflective feature, and produces additional multi-path signal components by reflection.

Step 4 P₄: the reader 1 executes the subsequent readout period. Preferably, during the subsequent readout period, the reader 1 will send no more selecting commands, so as to avoid the labels S1 of the tags 21, 22 being re-set to A again. In other words, in the subsequent readout period, only those tags 23 which are not read successfully in the previous readout periods are selected for querying in the subsequent readout period, such that it can avoid re-reading the tags 21,22 which have already been read successfully, thereby improving the reading rate of the system. The reader 1 directly sends the query command to read the tags (this time it is tag 23) whose labels Si are still A. During the subsequent readout period, since the multi-path signal components arriving at the tag 23 have changed, the tag 23 is no longer at the communication blind spot after the multi-path signal components are combined, and therefore it is read successful by the reader 1 with its label S1 being set to B.

Step 5 P₅: the reader 1 combines the results read in the above two readout periods into a final reading result, and completes a reading process.

By then, after the above two readout periods the reader 1 can read all three tags 21, 22, and 23 successfully. A reading process in accordance with the present invention is formed by combining the above first readout period with the subsequent readout period. Since the reflection-transmission apparatus 3 presents a variable reflection feature or a variable transmission feature during each period, this allows the radiofrequency identification system 4 to have different field intensity distributions in each period and, therefore, by utilizing the time diversity effects to perform the communication the radiofrequency identification system 4 can achieve a higher overall success reading rate during a reading process, and achieve a better balance regarding the overall reading time.

In practical applications, a radiofrequency identification system 4 typically comprises a larger number of tags 21, 22, 23. The number of the subsequent readout periods can be increased correspondingly during a reading process, and in each subsequent readout period, the reflection-transmission apparatus 3 changes its reflection feature and its transmission feature, so as to achieve a better balance between the overall success reading rate and the overall reading time.

To sum up the above process, the so-called utilizing the time diversity effects to perform the communication is as follows: the reader 1 executes at least two readout periods during one reading process, where a first readout period is executed when the reflection-transmission apparatus 3 presents a first reflection feature and a first transmission feature, and a second readout period is executed when the reflection-transmission apparatus 3 presents a second reflection feature and a second transmission feature; and the reading results of all said readout periods are combined into an overall reading result of said reading process. In this example, the way that the reflection-transmission apparatus 3 changes its reflection feature and transmission feature is by making the reflection-transmission apparatus 3 present alternately a completely reflective feature or a completely transmissive feature. In an alternative embodiment, the impedance of a variable impedance unit is adjusted successively into different impedance values, so as to make it successively present different reflection features.

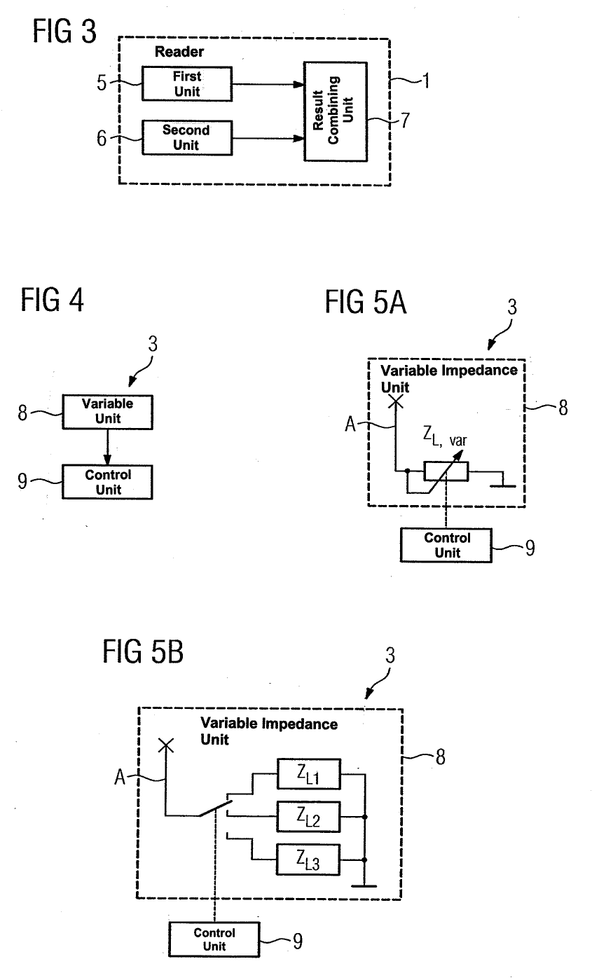

In order to implement the process of utilizing the time diversity effect to perform communication in accordance with the embodiments of the invention, the reader 1 comprises a first readout period unit 5, a second readout period unit 6 and a result combining unit 7, as shown in FIG. 3. Here, the first readout period unit 5 is used for executing a first readout period when the reflection-transmission apparatus 3 presents a first reflection feature and a first transmission feature. The second readout period unit 6 is used for executing a second readout period when the reflection-transmission apparatus 3 presents a second reflection feature and a second transmission feature. The result combining unit is used for combining the reading results of all readout periods into an overall reading result of the reading process.

FIG. 4 is an illustration of a schematic block diagram of a reflection-transmission apparatus 3 in accordance with an embodiment of the invention. The reflection-transmission apparatus 3 comprises a feature-variable unit 8 and a control unit 9. The feature-variable unit 8 is used to provide and change the reflection feature and the transmission feature presented to the radiofrequency, and it can have a variety of ways for specific implementations. The control unit 9 is used for controlling the feature-variable unit 8 to change the reflection feature and transmission feature during a communication process.

In the schematic block diagram of the reflection-transmission apparatus 3 shown in FIGS. 5A and 5B, the feature-variable unit comprises an antenna A and a variable impedance unit. In the embodiment shown in FIG. 5a, the above variable impedance unit can be realized by an adjustable load resistor Z_{L,var}. Here, the adjustable load resistor Z_{L,var} adjusts its impedance value under the control of the control unit 9, so as to change the reflection feature and the transmission feature presented at the radiofrequency by the antenna A. In the embodiment shown in FIG. 5b, the above variable impedance unit 8 is realized by several load resistors Z_{L1}, Z_{L2} and Z_{L3} having different impedance values, where the antenna A can be connected with one of the load resistors by a shift switch. The control unit controls the switch to change to the load resistors having different impedance values, so as to change the reflection feature and the transmission feature presented at the radiofrequency by the antenna A.

Specifically, if the complex conjugates of the load impedance and the antenna impedance match, then the variable impedance unit will present 50% of the reflection feature and 50% of the transmission feature. When the load impedance is zero, the reflection of the antenna A reaches the maximum, i.e., substantially presenting a completely reflective feature. When the load impedance tends to infinity (open circuit), the reflection of the antenna A is minimum, i.e., substantially presenting a completely transmissive feature. When the load impedance is changed between zero and infinity, the reflection feature and the transmission feature of the variable impedance unit also change correspondingly between the completely reflective feature and the completely transmissive feature.

In order to strengthen the reflective effect, the reflection-transmission apparatus 3 shown in FIG. 4 can adopt an antenna array composed of more than one antenna A. The load impedance connected to each antenna A can be the same, or it also can be different. The embodiment shown in FIG. 4 is simple and can be realized at low-cost.

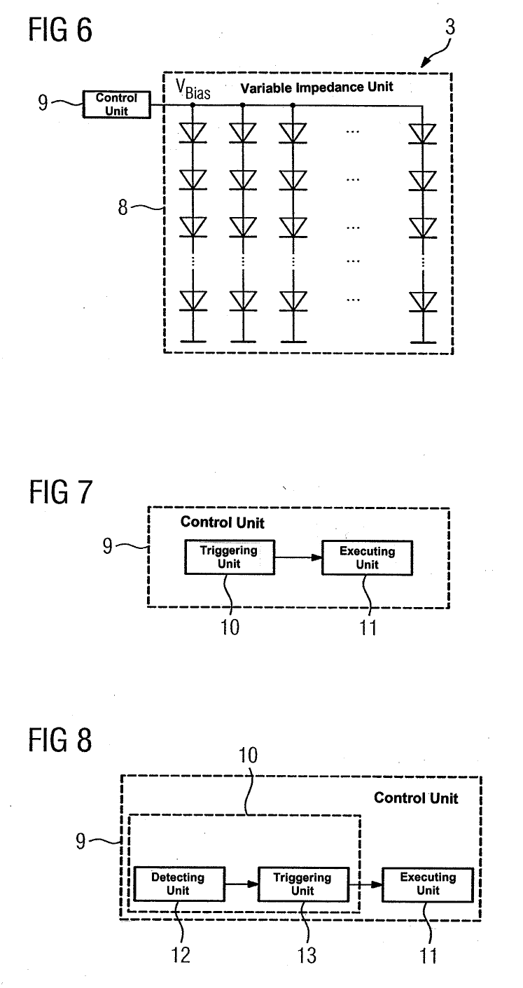

FIG. 6 is an illustration of a schematic block diagram of the reflection-transmission apparatus 3 in accordance with an alternative embodiment, where the feature-variable unit is realized by using a wire grating formed by a biased diode and conductive wire sections.

When the bias voltage V_{Bias} applied to the PIN diode is a large enough reverse bias voltage, the PIN diode presents a non-conductive state. When the bias voltage V_{Bias} applied thereto is a large enough forward bias voltage, the PIN diode presents a low impedance state, i.e., a conductive state. When the PIN diode is in non-conductive state, the conducting wire sections between the diodes are not connected with each other. Since every conducting wire section is much shorter than the half-wavelength of the radiofrequency, they reflect only a small portion of the radiofrequency, and mainly present the transmissive feature. When the PIN diode is in the conductive state, a wire grating is then formed by connecting the conducting wire sections, and the size is no longer shorter than the half-wavelength of the radiofrequency, thereby producing a stronger reflection to the radio signal, and presenting a mainly reflective feature.

Specific parameters, such as the spacing of the PIN diodes and the length, the number and the spacing of the wire sections, can be set by the required reflection feature. It is also possible to apply different bias voltages to different parts of the wire grating to adjust its reflection feature.

Likewise, several of the above wire gratings can be combined to strengthen the reflection effect. These wire gratings can be controlled by one and same control unit 9, or they can also be controlled separately by different control units 9. The control unit 9 of the reflection-transmission apparatus 3 is used for controlling the feature-variable unit 8 to change the reflection feature and transmission feature during the communication process. The control unit 9 can control the feature-variable unit 8, to make it adjust its reflection feature and transmission feature periodically, or to change its reflection feature and transmission feature randomly, or preferably, to change its reflection feature and transmission feature synchronously with the readout period of the radiofrequency identification system 4 to achieve a better balance between the successful reading rate and the reading speed. More preferably, the control unit 9 can control the feature-variable unit 8, so as to make it change its reflection feature and transmission feature at the beginning of every readout period of the radiofrequency identification system 4, thus avoiding interference in communication between the reader 1 and the tags 21, 22, 23.

FIG. 7 is an illustration of a schematic block diagram of a control unit 9 in accordance with an embodiment of the invention. The control unit 9 comprises a triggering unit 10 and an executing unit 11. The triggering unit 10 is used for periodically or randomly transmitting a triggering instruction for changing said reflection feature and transmission feature synchronously with the readout period of the radiofrequency identification system 4. The executing unit 11 is used for controlling the feature-variable unit 8 to change said reflection feature and transmission feature after receiving said triggering instruction from the triggering unit 10.

In the preferred embodiment shown in FIG. 8, in which the control unit 9 controls the feature-variable unit 8 to change its reflection feature and transmission feature synchronously with the readout period of the radiofrequency identification system 4, the triggering unit 10 further comprises a signal detecting unit 12 and a synchronous triggering unit 13. The signal detecting unit 12 is used for detecting a signal sent by the reader 1 of the radiofrequency identification system 4. The synchronous triggering unit 13 is used for determining the beginning of one readout period according to the signal detected by the signal detecting unit 12, and at the beginning of one readout period, transmitting a triggering instruction for changing the reflection feature and transmission feature.

Specifically, the signal sent by the reader 1 can be detected by the signal detecting unit 12 by disposing a special receiving antenna or by coupling a coupling unit to a receiving and transmitting path of the reader 1. The synchronous triggering unit can determine whether a readout period is beginning by judging a specially set pilot signal of the readout period sent by the reader 1, and it also can determine whether a readout period is beginning by judging the rising edge of the signal sent by the reader 1. The method of performing the control can be attained by causing the reflection-transmission apparatus 3 to alternately present a completely reflective feature or a completely transmissive feature as shown in the previous example, and it can also be attained by adjusting successively the impedance of variable impedance units to different impedance values, thereby causing the reflection-transmission apparatus 3 to present different reflection features successively.

The above examples mainly illustrate the present contemplated embodiments of the invention by having the reflection-transmission apparatus 3 change its reflection feature in an exemplary manner. In fact, in the above examples, the above reflection-transmission apparatus 3 can also change its transmission feature simultaneously with when it changes its reflection feature. If the transmission feature of the transmission apparatus 3 changes with time, the multipath signal components that pass through it at different times will also change at different degrees accordingly, and this means that the field intensity in the system will also be changed with time in different degrees, which will also facilitate the reduction in the probability of the occurrence of the continual communication blind spots.

The disclosed embodiment of the invention are particularly useful in an environment of the radiofrequency identification system 4. In addition, for a wireless local area network (WLAN) in which a coherent bandwidth of channels is much smaller than a utilized bandwidth, the continuous communication blind spots may also appear therein. In this case, according to the reflection-transmission apparatus and/or the transmission apparatus introduced by the contemplated embodiments of the invention in which its features change with time, the probability of the occurrence of the continuous communication blind spots in the system can also be reduced. In addition, in a multiple-input multiple-output (MIMO) system, such as the WLAN based on IEEE wireless networking standard 802.11n, in accordance with the disclosed embodiment of the reflection-transmission apparatus and/or the transmission apparatus in which its features change with time, a rich scattering environment can be generated, thereby weakening the channel correlation encountered by different receiving and transmitting antennas, and furthermore improving the properties of the channels.

The disclosed embodiments in accordance with the invention are easy to implement, have low costs and low energy consumption, and the aim of reducing the continuous communication blind spots can be realized without any change to the existing apparatus in the radiofrequency system 4 or with limited changes, thereby improving the communication success rate and the communication efficiency of the system 4.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

1.-19. (canceled)

20. A communication method for a radio system, comprising:
setting up a reflection-transmission apparatus in the radio system;
during a communication process, changing reflection and transmission features of the reflection-transmission apparatus presented at a radiofrequency to introduce a multi-path signal component which changes with time; and
during the communication process, transmitting communication signals by a transmitting apparatus to a receiving apparatus, receiving and combining the multi-path signal component of said communication signals by the receiving apparatus and performing communication in the radio system utilizing time diversity effects.

21. The method as claimed in claim 20, wherein said radio system is a radiofrequency identification system comprising a reader and at least one tag.

22. The method as claimed in claim 21, wherein the reflection and transmission features presented at the radiofrequency by said reflection-transmission apparatus are changed synchronously with a readout period of the radiofrequency identification system.

23. The method as claimed in claim 22, wherein synchronizing with said readout period of the radiofrequency identification system comprises:
detecting a signal sent by the reader;
analyzing the detected signal to determine a beginning of one readout period; and
triggering the change of the reflection and transmissions feature of the reflection-transmission apparatus at the beginning of the one readout period.

24. The method as claimed in claim 23, wherein the beginning of one readout period is determined at a rising edge of said detected signal.

25. The method as claimed in claim 21, wherein said utilizing the time diversity effects to perform communication by said radio system comprises:
executing, by the reader, at least two readout periods during one reading process;
wherein a first readout period is executed when the reflection-transmission apparatus presents a first reflection feature and a first transmission feature, and a second readout period is executed when the reflection-transmission apparatus presents a second reflection feature and a second transmission feature; a reading results of all said at least two readout periods being combined into an overall reading result of said reading process.

26. The method as claimed in claim 25, wherein during said one reading process, the reader queries all tags in the first readout period, and in subsequent readout periods, queries only those tags which are not read successfully in a previous readout period.

27. The method as claimed in claim 21, wherein said reflection-transmission apparatus is disposed within a range of a sight distance communication from the reader.

28. The method as claimed in claim 20, wherein the reflection and transmission features presented at the radiofrequency by the reflection-transmission apparatus are changed to cause the reflection-transmission apparatus to alternately present one of a completely reflective feature and a completely transmissive feature.

29. The method as claimed in claim 20, wherein the reflection and transmission features presented at the radiofrequency by the reflection-transmission apparatus are changed by changing an impedance of the reflection-transmission apparatus.

30. The method as claimed in claim 20, wherein the radio system is a wireless local area network system.

31. A reflection-transmission apparatus, comprising:
a feature-variable unit configured to provide and change reflection and transmission features presented at a radiofrequency; and
a control unit configured to control the feature-variable unit to change the reflection and transmission features during a communication process in which communication signals are transmitted by a transmitting apparatus to a receiving apparatus.

32. The reflection-transmission apparatus as claimed in claim 31, wherein said feature-variable unit comprises an antenna and a variable impedance unit operatively coupled to the antenna; and wherein said variable impedance unit changes the reflection and transmission features presented at the radiofrequency by the antenna by changing its impedance.

33. The reflection-transmission apparatus as claimed in claim 31, wherein said feature-variable unit comprises a wire grating formed by a biased diode and conducting wire sections; and wherein the reflection and transmission features presented at the radiofrequency by said wire grating are changed by changing a DC bias voltage applied to a biased diode.

34. The reflection-transmission apparatus as claimed in claim 31, wherein said control unit comprises:
a triggering unit configured to transmit a triggering instruction for changing the reflection and transmissions feature synchronously with a readout period of a radiofrequency identification system comprising the transmitting apparatus and the receiving apparatus; and
an executing unit configured to control the feature-variable unit to change the reflection and transmissions feature after receiving the triggering instruction from the triggering unit.

35. The reflection-transmission apparatus as claimed in claim 34, wherein said triggering unit comprises:
a signal detecting unit configured to detect the communication signal sent by the transmitting apparatus, which comprises a reader of the radiofrequency identification system; and
a synchronous triggering unit configured to determine a beginning of one readout period according to the signal detected by the signal detecting unit and to transmit, at the beginning of said one readout period, a triggering instruction for changing the reflection and transmission features.

36. A radiofrequency identification system, comprising:
at least one tag;
a reader configured to perform communication with the at least one tag by utilizing time diversity effects; and
a reflection-transmission apparatus configured to provide and change reflection and transmission features presented at a radiofrequency during a communication process to introduce a multi-path signal component that changes with time.

37. The radiofrequency identification system as claimed in claim 36, wherein said reader comprises:
a first readout period unit configured to execute a first readout period when the reflection-transmission apparatus presents first reflection and transmission features;
a second readout period unit configured to execute a second readout period when the reflection-transmission apparatus presents second reflection feature and transmission features;
a result combining unit configured to combine reading results of the first and second readout periods into an overall reading result of a reading process.

38. The radiofrequency identification system as claimed in claim 36, wherein said reflection-transmission apparatus comprises:
a feature-variable unit configured to provide and change the reflection and transmissions feature presented at the radiofrequency; and
a control unit configured to control the feature-variable unit to change the reflection and transmission features during the communication process.
